(19) United States
(12) Patent Application Publication
(10) Pub. No.: US 2026/0154022 A1
(43) Pub. Date: Jun. 4, 2026

(54) Eye-Worn Device for Displaying Information to an Observer

(71) Applicant: Telefonaktiebolaget LM Ericsson (publ), Stockholm (SE)

(72) Inventors: Alexander Hunt, Lund (SE); Andreas Kristensson, Lund (SE)

(21) Appl. No.: 19/123,864

(22) PCT Filed: Oct. 31, 2022
(86) PCT No.: PCT/SE2022/050992

§ 371 Date: Apr. 24, 2025

(51) Int. Cl. G06F 3/14; G02C 7/04; G02C 7/08; G06F 3/01; G06F 21/35

(52) U.S. Cl. CPC G06F 3/14; G02C 7/04; G02C 7/083; G06F 3/011; G06F 21/35

(57) ABSTRACT

Methods and apparatuses disclosed herein use an outward-facing display of an eye-worn device (10) to provide indications (42) to an observer device (120) having line-of-sight to the eye-worn device (10). Example indications (42) include solid colors or patterns, which may or may not use color, serving as authentication symbols. In one or more embodiments, the eye-worn device (10) displays or updates an indication (42) on a responsive basis, as part of authentication procedure. Various display types may be used, with one or more embodiments relying on the use of microelectromechanical system (MEMS) mirrors, and the indications (42) may be provided using visible light or light in other wavelengths.

### TECHNICAL FIELD

Methods and apparatuses disclosed herein relate to eye-worn devices for displaying information to an observer.

### BACKGROUND

Conventional contact lenses provide optical correction or aesthetic enhancement. Continuing technical advances underlie the development of smart contact lenses, which may offer optical correction and include electronics. Development of smart contact lenses spans multiple areas of interest.

Physiological sensing is one area of interest in which a smart contact lens includes one or more physiological sensors, along with supporting circuitry and a power source. Example sensors include pressure sensors for monitoring intra-ocular pressure of the wearer, glucose sensors for monitoring blood glucose levels of the wearer, and temperature sensors for monitoring temperature of the wearer.

Augmented reality (AR) is one area of interest in which a smart contact lens includes one or more displays, along with supporting circuitry and a power source. A known approach for smart contact lenses in the AR context uses a rigid or semi-rigid substrate, which may comprise multiple layers and carries a small display centered on the eye of the wearer for the projection of visible light into the eye. Because of its diminutive size and on-eye placement, the display does not obstruct the vision of the wearer, while allowing for the projection of visible light into the eye for superimposition of text, shapes, or other visual information onto the field-of-view of the wearer.

### SUMMARY

Methods and apparatuses disclosed herein use an outward-facing display of an eye-worn device to provide indications to an observer device having line-of-sight to the eye-worn device. Example indications include display colors or patterns serving as authentication symbols and, in one or more embodiments, displayed or updated on a responsive basis, as part of authentication procedure. Various display types may be used, with one or more embodiments relying on the use of microelectromechanical system (MEMS) mirrors, and the indications may be provided using visible light or light in other wavelengths.

One embodiment comprises an eye-worn device that includes a substrate defining an annular area surrounding a central opening corresponding to a lens area of the eye of a wearer, a display. The display covers at least a portion of the annular area and faces outward for displaying an indication to an observer device having a line-of-sight to the eye-worn device. As an example, the eye-worn device is configured to receive an authentication request and display the indication as an authentication response.

A related embodiment comprises a method of operation by an eye-worn device having a display that faces outward for displaying indications to an observer device having a line-of-sight to the eye-worn device. The method includes receiving an authentication request from the observer device or from an intermediary device that is communicatively coupled to the observer device, and displaying an indication as an authentication response, for optical detection by the observer device.

Another embodiment comprises a system that includes an eye-worn device comprising a substrate defining an annular area surrounding a central opening corresponding to a lens area of the eye of a wearer, and a display. The display covers at least a portion of the annular area and facing outward for displaying an indication to an observer device having a line-of-sight to the eye-worn device. The system further includes the observer device, which comprises authentication interface circuitry configured for optical detection of the indication as a detected indication and processing circuitry configured for authentication of the detected indication. In at least one embodiment, the system further includes an intermediary device that communicates with the eye-worn device, such as sending authentication requests to the eye-worn device or sending signaling to the eye-worn device that defines the indication.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a diagram of an eye-worn device according to an example embodiment.

FIG. 2 is another view of the eye-worn device of FIG. 1.

FIG. 3 is a block diagram of a pixel array according to an example embodiment.

FIGS. 4 and 5 are block diagrams of example microelectromechanical system (MEMS) mirror details.

FIG. 6 is a block diagram of example liquid crystal display (LCD) details.

FIG. 7 is a block diagram of an external device according to an example embodiment, where the external device is configured to charge and program an eye-worn device.

FIGS. 8 and 9 are logic flow diagrams of respective methods of operation by an eye-worn device according to example embodiments.

FIG. 10 is a block diagram of an observer device and an intermediary device according to example embodiments.

FIG. 11 is a logic flow diagram of a method of operation by an eye-worn device according to another example embodiment.

FIG. 12 is a logic flow diagram of a method of operation by observer and intermediary devices according to an example embodiment.

FIG. 13 is a logic flow diagram of a method of operation by an eye-worn device according to another example embodiment.

FIG. 14 is a logic flow diagram of a method of operation by observer and intermediary devices according to another example embodiment.

### DETAILED DESCRIPTION

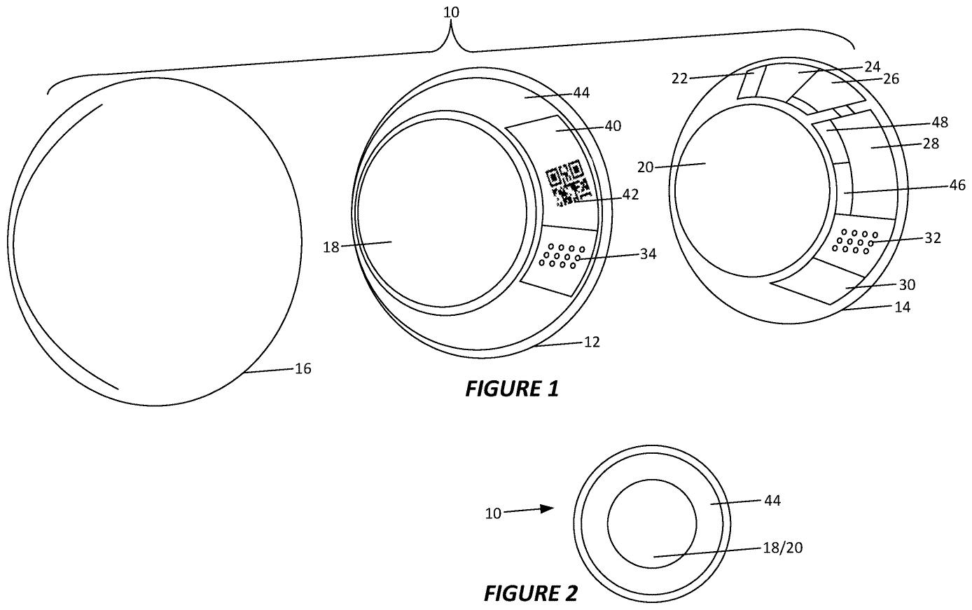

FIG. 1 illustrates an eye-worn device 10 according to an example embodiment. In the illustrated embodiment, the eye-worn device 10 includes a substrate 12 that stacks with a further substrate 14 to form a multi-layer substrate. A covering layer 16 covers the multilayer substrate. As a non-limiting example, the substrates 12 and 14 and the covering layer 16 are made of polydimethylsiloxane (PDMS) or other suitable material for on-eye usage, such as poly(2-hydroxyethyl methacrylate) (pHEMA).

The eye-worn device 10 carries electronic circuitry in one or more embodiments, such as in a portion of the eye-worn device 10 that corresponds to the iris and/or sclera of the eye, when the eye-worn device 10 is positioned properly on the eye of its wearer. However, the substrates 12 and 14 have central openings 18 and 20, respectively, leaving an unobstructed field of view for the wearer. Optical correction is provided by the covering layer 16 in one or more embodiments, making the eye-worn device 10 suitable for use by wearers that use prescription eyeglasses or contact lenses.

As a “smart” contact lens, the eye-worn device 10 in the illustrated embodiment includes a charging feature 22 that comprises electrical contacts for galvanic connection to an external source of power. Additionally, or alternatively, the charging feature 22 comprises a coil arrangement for contactless charging via inductive coupling. A power storage element 24 stores charge provided via the charging feature 22. Examples of the power storage element 24 are a battery or a super capacitor but these examples are non-limiting and the power storage element 24 may be based on any technology feasible for powering a smart contact lens.

Power regulation circuitry 26 may regulate charging current regulate power from the power storage element 24 for other electronic circuitry onboard the eye-worn device 10, such as control circuitry 28 and communication circuitry 30. In one or more embodiments, the communication circuitry 30 comprises radiofrequency circuitry (RF) that at a minimum includes a RF receiver. In at least one embodiment, the communication circuitry 30 comprises a RF transceiver comprising a RF transmitter and a RF receiver. The communication circuitry 30 or the control circuitry 28 includes baseband processing circuitry for processing signals for transmission from the RF transmitter and for processing signals received via the RF receiver.

In embodiments that use a multi-layer substrate rather than a single-layer substrate, the respective substrate layers may include complementary electrical contacts for carrying signals and power between the respective layers. FIG. 1 illustrates an example arrangement, where the substrate layer 14 includes inter-layer contacts 32 that mate with inter-layer contacts 34 on the substrate layer 12. These contacts carry display control signals from the control circuitry 28 to a display 40 that is operative to display one or more types of indications 42.

The indication 42 comprises a color or a pattern having some defined meaning, such as comprising a particular color or a particular pattern at a particular time, for serving as an authentication symbol. Thus, the indication 42 should be broadly understood as any form of impresa that is used as an identifying mark, such as in an authentication procedure, where the color or pattern displayed by the display 40 serves as an authentication symbol. Color may be displayed as a uniform color field or multiple colors may be used to create a pattern. Other patterns need not depend on color. For example, a QR code or other shape-based pattern may be formed as a pattern of light and dark, e.g., based on controlling pixels in the display 40.

The type(s) of indications 42 displayable by the display 40 depends on the design of the display 40. In some embodiments, the display 40 is monochromatic and in other embodiments the display 40 is a color display. The display 40 may be reflective or transmissive, with reflective implementations offering the advantage of lower-power operation suiting the limited energy storage available onboard the eye-worn device 10. In one or more embodiments, the indication 42 has a certain wavelength, which may be one among multiple wavelengths the display 40 is operative to transmit or reflect. The wavelength may, therefore be an aspect of authentication.

The substrate 12 defines an annular area 44 that surrounds the central opening 18 corresponding to a lens area of the eye of a wearer. See FIG. 2 for a further view of the central opening 18 and the surrounding annular area 44.

The display 40 covers at least a portion of the annular area 44 and faces outward for displaying an indication 42 to an observer device—not shown—having a line-of-sight to the eye-worn device 10. Particularly, the observer device has optical-detection circuitry and associated processing circuitry that allows it to see or otherwise sense and evaluate the displayed indication 42.

In at least one embodiment, the eye-worn device 10 includes a sensor 46 to detect the eye of its wearer. For example, the eye-worn device 10 activates responsive to detecting its placement onto the eye of the wearer. In at least one embodiment, the sensor 46 is a capacitive sensor.

The indication 42 displayed on the outward-facing display 40 is an authentication symbol, for example. The authentication symbol is a color or pattern, where the pattern may or may not use different colors. That is a pattern may comprise shapes and/or colors. The eye-worn device 10 in one or more embodiments is configured to determine the indication 42 based on at least one of: information received via the communication circuitry 30 of the eye-worn device 10, or information stored in a memory 48 of the eye-worn device 10.

The display 40 in one or more embodiments is bi-stable for persistent displaying of the indication 42 without onboard power, and the electrical contacts 32, 34 in such embodiments may be configured to provide display control to an external device, for setting the indication 42. In one or more embodiments, the control circuitry 28 provides the display control—i.e., sets the bi-stable display 40—but relies on external power coupled to the eye-worn device 10 to provide such control.

In at least one embodiment, the control circuitry 28 is configured to control the display 40 and configured to set the indication 42 responsive to signaling received via a set of electrical contacts 32 or received wirelessly via the communication circuitry 30. More generally, in one or more embodiments, the communication circuitry 30 is configured to receive wireless signaling and the control circuitry 28 is configured to set the indication 42 responsive to the wireless signaling.

The control circuitry 28 is configured, for example, to respond to an authentication request signal received via the communication circuitry 30, by controlling the display 40 to display the indication 42 as an authentication response to the authentication request. In at least one such embodiment, the control circuitry 28 is configured to clear or reset the indication 42 after an elapsed time from receipt of the authentication request signal. Further, in at least one embodiment, the control circuitry 28 is configured to update the indication 42, responsive to further authentication signaling received via the communication circuitry 30. In at least one embodiment, the control circuitry 28 is configured to update the indication 42 and to transmit, via the communication circuitry 30, signaling indicating the update. Such operation means that the eye-worn device 10 in one or more embodiments apprises another device of the indication 42 that is currently being displayed or is to be displayed.

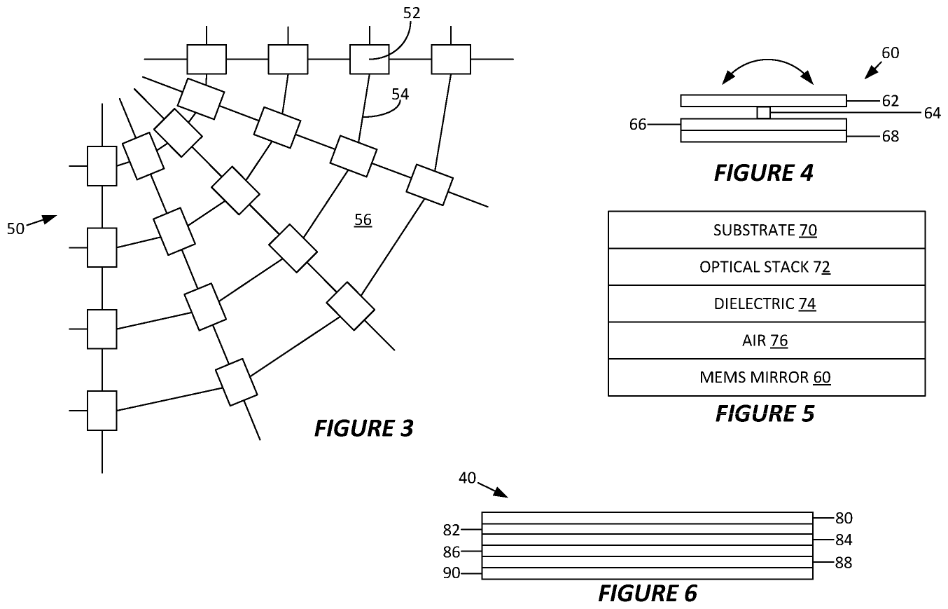

The display 40 is a reflective display in one or more embodiments. In at least one embodiment, the display 40 comprises a pixel array. FIG. 3 illustrates at least a portion of an example pixel array 50 comprising an array of pixels 52. Depending upon the display technology used to implement the display 40, the pixels 52 may be electrically connective via signal lines 54, such as row/column lines or a similar arrangement corresponding to the geometrical arrangement of the pixels 52, that provides for individual addressability and control of the pixels 52. The material 56 between respective pixels 52 is transparent in one or more embodiments and is opaque in one or more other embodiments. Further, in one or more embodiments, the material 56 is reflective, such as reflective at a specific wavelength or wavelengths. In at least one embodiment, these regions of material 56 between the respective pixels 52 may operate as a further type of pixel, or may otherwise be controllable in terms of reflected or transmitted wavelength.

Pixels 52 of the pixel array 50 comprise Microelectromechanical Systems (MEMS) mirrors in one embodiment, with the mirrors forming the indication 42 in dependence on an applied mirror actuation pattern. FIG. 4 illustrates an example MEMS mirror 60 assembly 60 that includes an actuatable mirror 62 connected via hinge 64, along with metallization and CMOS layers 66 and 68. FIG. 5 adds further details for an overall stack arrangement, including a glass substrate 70, one or more optical layers 72, e.g., for chromatic filtering, a dielectric layer 74, an air gap 76, and the MEMS mirror 60.

FIG. 6 illustrates another implementation of the display 40, where the individual pixels 52 comprise liquid crystal display (LCD) elements. Each such element is based on a stacked arrangement including a first glass substrate 80, one or more color filters 82, a common electrode layer 84, a liquid crystal layer 86, a thin film transistor layer 88, and a second glass substrate 90.

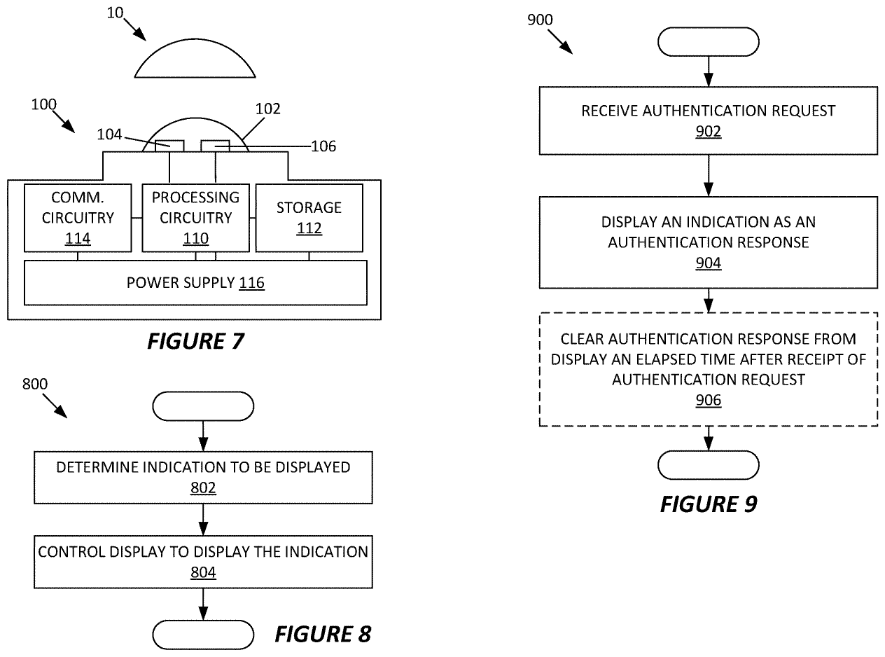

FIG. 7 illustrates one embodiment of a companion device 100, which also may be referred to as a type of supporting device. The companion device 100 provides a base 102 on which the eye-worn device 10 rests, such as for charging and programming operations. For example, a charging feature 104 couples with the charging feature 22 of the eye-worn device 10, with the connection being galvanic or inductive.

A signaling feature 106 provides for communicative coupling with the eye-worn device 10. In one embodiment, the signaling feature 106 comprises a wireless interface that exchanges signaling with the eye-worn device 10, e.g., using near field communications supported by the communication circuitry 30 of the eye-worn device. In one or more other embodiments, the signaling feature 106 comprises a set of electrical contacts that provides connectivity to the eye-worn device 10. In one or more embodiments, the companion device 100 directly controls the display 40, e.g., such as where the display 40 is bi-stable, such that it can be controlled to display a particular indication 42 and hold that indication 42 after removal of power. For example, in at least one embodiment the display 40 comprises a pixel array 50 of pixels 52, each comprising a bi-stable MEMS mirror, for statically holding a last applied mirror actuation pattern.

In one or more other embodiments, the signaling feature 106 couples the companion device 100 with the control circuitry 28, for transferring information defining one or more indications 42. For example, information defining one or more indications 42 is transferred to the control circuitry 28 and stored in the memory 48, for later recall and use by the control circuitry 28 in setting the display 40 to show a particular indication 42 at a particular time.

Other elements of the companion device 100 include processing circuitry 110, such as one or more microprocessors that are configured based on executing computer program instructions stored in storage 112. The storage 112 comprises one or more types of computer-readable media and may store configuration data and other information, such as information defining particular indications 42. Communication circuitry 114 comprises, for example, one or more RF transceivers for communicating with one or more types of external devices. A power supply 116 provides operating power to the various other elements.

FIG. 8 illustrates a method 800 of operation by an eye-worn device 10 in an example embodiment. Included steps or operations comprise determining (Block 802) an indication 42 to be displayed and controlling (Block 804) the display 40 to display the determined indication 42. These operations are performed by the control circuitry 28 of the eye-worn device 10. “Determining” the indication 42 comprises, for example, receiving signaling that defines or otherwise identifies the indication 42 to be displayed. For example, the eye-worn device 10 stores data in its memory 48 corresponding to multiple indications 42 and it receives signaling, e.g., via the communication circuitry 30, that conveys an index or other mapped value that points to a particular one of the stored indications 42 as a selected indication. The control circuitry 28 responds by reading out the stored data corresponding to the selected indication 42 and “writes” the selected indication 42 to the display 40.

FIG. 9 illustrates a method 900 of operation by an eye-worn device 10 in another example embodiment. The method 900 may subsume the operations of the method 800 in terms of controlling the display 40 to display a particular indication 42. Illustrated operations in the method 900 include receiving (Block 902) an authentication request and displaying (Block 904) an indication 42 as an authentication response. The method 900 may include clearing the authentication response from the display an elapsed time after receipt of the authentication request.

The indication 42 in such contexts serves as an authentication symbol. A particular color is one example of an authentication symbol, such as displaying blue, green, red, or some other color that serves as an authentication value in the involved authentication. Other authentication symbol examples include patterns, which may or may not use color. A QR code or other such pattern is an example of an authentication symbol. The resolution of the display 40 and the maximum intended observational distance place limits on the intricacy or pattern fineness of a displayed indication 42, and in one or more embodiments, the eye-worn device 10 is operative to use a selected type of indication 42 in dependence on received signaling or based on programming via the companion device 100. For example, in a situation not requiring higher security and/or where the observer device has limited optical detection capabilities, the type of indication 42 used by the eye-worn device 10 may be limited to simple fields of color or simple, coarse patterns.

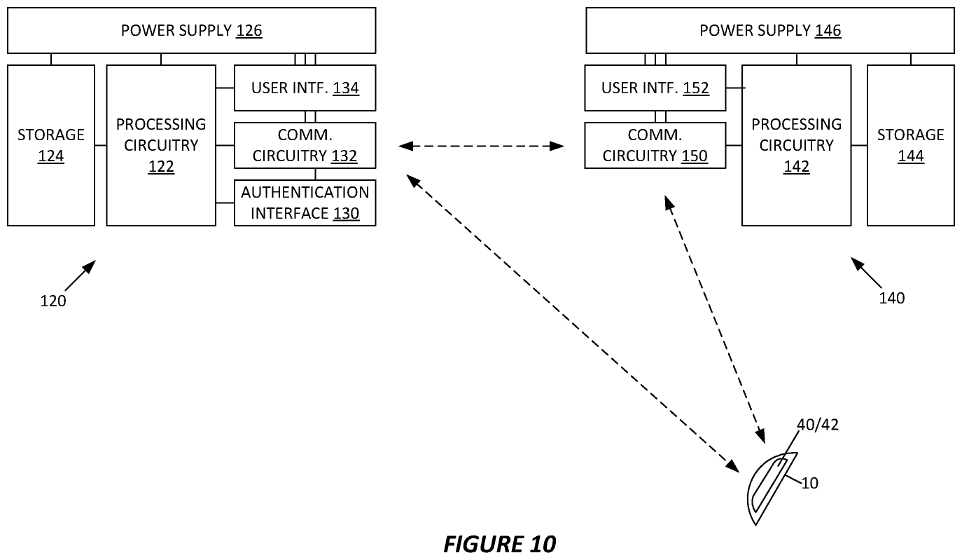

FIG. 10 illustrates an example system that includes an eye-worn device 10 and another device 120 operative as an observer device that detects and processes an indication 42 displayed by the eye-worn device 10.

The observer device 120 comprises, for example, an access control device, such as a doorway control device that authenticates individuals before allowing them to pass through the doorway. In another example, the observer device 120 is a media set top box or other media controller that uses authentication to grant access to media content or uses authentication to grant access to restricted types of media. In another example, the observer device 120 is a computer or personal computing device, such as a tablet or smartphone, that unlocks or provides controlled levels of access in dependence on performing user authentication. Of course, these examples are not limiting and the observer device 120 may be essentially any apparatus that uses optical sensing to detect and process an indication 42 displayed by the eye-worn device 10, for authentication of the wearer.

In some embodiments or in some circumstances, the observer device 120 communicates directly with the eye-worn device 10, such as by wirelessly transmitting an authentication request that is received and acted on by the eye-worn device 10. In other embodiments or in other circumstances, an intermediary device communicates with the eye-worn device 10 and communicates with the observer device 120. For example, the intermediary device may use proprietary RF waveforms and/or protocols as the basis for communicating with the eye-worn device 10, while providing an industry-standard radio interface for communicating with the observer device 10. Such an arrangement allows the observer device 120 to use, for example, Bluetooth or other standardized radio signaling to initiate an authentication procedure, with the intermediary device then signaling the eye-worn device 10 to display an indication 42 for detection by the observer device 120.

The observer device 120 in the example embodiment includes processing circuitry 122, e.g., one or more microprocessors that are configured according to the execution of computer program instructions stored in storage 124. Storage 124 comprises one or more types of computer-readable media and may include volatile storage, non-volatile storage, or both. A power supply 126 provides regulated power to the processing circuitry 122 and the storage 124, and to other elements of the device.

Other elements include, for example, an authentication interface 130 that comprises a camera or other optical sensing subassembly that is operative to detect indications 42 displayed by the display 40 of the eye-worn device 10, at least within defined design parameters, such as maximum observation distance, etc. Communication circuitry 132 comprises, for example, one or more wireless transceivers, e.g., for communicating with the eye-worn device 10 and/or with an intermediary device. Depending on its intended use, the observer device 120 includes a user interface 134, which comprises a touchscreen and/or physical interface buttons, for example.

The device 140 also shown in FIG. 10 serves as an example intermediary device. The intermediary device 140 in the example embodiment includes processing circuitry 142, e.g., one or more microprocessors that are configured according to the execution of computer program instructions stored in storage 144. Storage 144 comprises one or more types of computer-readable media and may include volatile storage, non-volatile storage, or both. A power supply 146 provides regulated power to the processing circuitry 142 and the storage 144, and to other elements of the device.

Other elements include, for example, communication circuitry 150 and a user interface 152. The communication circuitry 150 comprises, for example, one or more wireless transceivers, e.g., for communicating with the eye-worn device 10 and/or with the observer device 120. For example, the communication circuitry 150 includes a standardized radio interface for communicating with the observer device 120, e.g., to carry out an authentication procedure involving the eye-worn device 10 and includes another radio interface for communicating with the eye-worn device 10. Of course, the communication circuitry 150 may include a computer network interface, such as a wired Ethernet interface and/or a Wi-Fi interface, for connecting to the Internet. The same may be true for the communication circuitry 132 of the observer device 120.

Further, in at least one embodiment, any two or more among the observer device 120, the intermediary device 140, and the eye-worn device 10 are configured for encrypted inter-device communications, as an added measure of security for authentication procedures involving the eye-worn device 10. Communications encryption prevents, for example, an intercepting device from learning the indication 42 to be displayed by the eye-worn device 10 for the performance of an authentication procedure. Encryption may be based on a shared secret. In one example, the shared secret is decided by or otherwise obtained from a remote server.

Correspondingly, in at least one embodiment, the observer device 120 need not communicate directly with the intermediary device 140 via a local radio link. Instead, the observer device 120 may transmit Internet Protocol (IP) signaling to a remote computer server providing a cloud-based authentication service, with the remote computer server then sending IP signaling to the intermediary device 140, to initiate an authentication procedure between the observer device 120 and the eye-worn device 10. In at least one such example, the observer device 120 and the remote server exchange encrypted communications, with the remote server sending encrypted signaling to the observer device 120 that identifies the indication 42 to be displayed by the eye-worn device 10 for authentication. The remote server and/or the intermediary device 140 may also indicate when or for how long the indication 42 will be displayed. Correspondingly, the observer device 120 performs optical detection and processes or evaluates any detected indication to see whether it matches the indication that was supposed to be displayed.

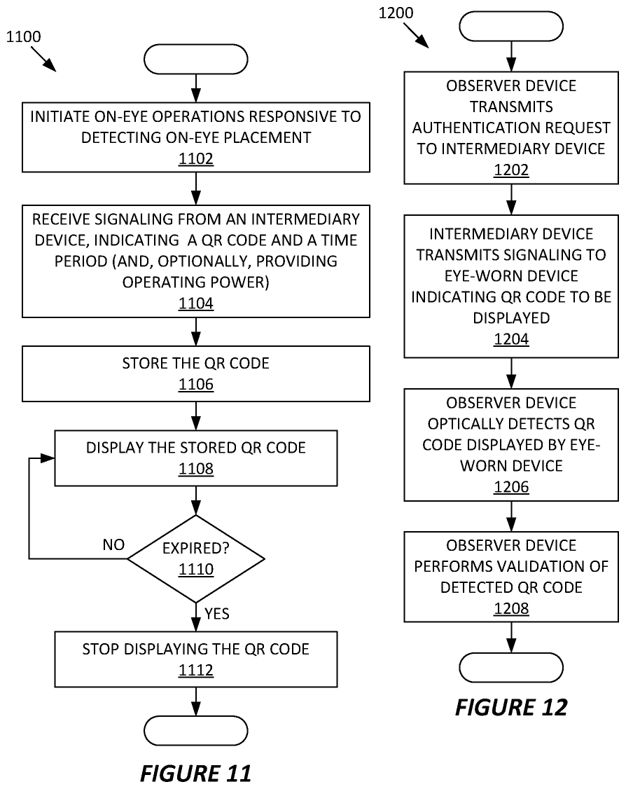

FIG. 11 illustrates a method 1100 of operation by an eye-worn device 10 in one embodiment, with FIG. 12 illustrating a corresponding method 1200 of operation involving an observer device 120 and an intermediary device 140. Together, FIGS. 11 and 12 offer one example of overall system operations carried out by the system shown in FIG. 10.

The method 1100 includes the eye-worn device 10 initiating (Block 1102) operations responsive to detecting on-eye placement and at some subsequent time receiving (Block 1104) signaling from an intermediary device 140. The signaling indicates a QR code and a time period. The QR code serves as a particular indication 42 to be displayed in an authentication procedure and the time period defines for how long the eye-worn device 10 displays the QR code. In at least one embodiment, the signaling provides power to the eye-worn device 10, e.g., it provides the eye-worn device 10 with the power needed to display the QR code.

Operations continue with the eye-worn device 10 storing (Block 1106) the QR code and displaying (Block 1108) the stored QR code via the display 40. The eye-worn device 10 continues displaying the QR code for the specified time period and stops displaying it upon expiration of the time period (Blocks 1108, 1110, and 1112).

FIG. 12 illustrates corresponding authentication-procedure operations by the intermediary device 140 and the observer device 120, beginning with the observer device 120 transmitting (Block 1202) an authentication request to the intermediary device 140, and the intermediary device 140 responding by transmitting (Block 1204) signaling to the eye-worn device. That signaling indicates the QR code to be displayed and the time period for display and, as noted, may provide operating power to the eye-worn device 10. Although not shown explicitly, the intermediary device 140 may send an acknowledgement to the observer device 120, acknowledging receipt of the authentication request and it may send information identifying the QR code to be displayed by the eye-worn device 10 for authentication by the observer device 120, or the observer device 120 may obtain that information indirectly, e.g., over an Internet connection with a remote server that supports the authentication procedure.

Operations continue with the observer device 120 optically detecting (Block 1206) the QR code display by the eye-worn device 10, such that the observer device 120 obtains a detected QR code. The observer device 120 then performs validation of the detected QR code, e.g., by determining whether the detected QR code matches the QR code that was supposed to be displayed by eye-worn device 10 for authentication. Again, the observer device 120 may know the QR code that was supposed to be displayed based on any one or more techniques. For example, there may one or a limited number of QR codes used for authentication and these are provisioned in the observer device 120, or the observer device 120 communicates with a remote server via an Internet or other connection to learn the QR code that is supposed to be displayed, or the observer device 120 uses a local wireless connection with the intermediary device 140 to learn the QR code that is supposed to be displayed.

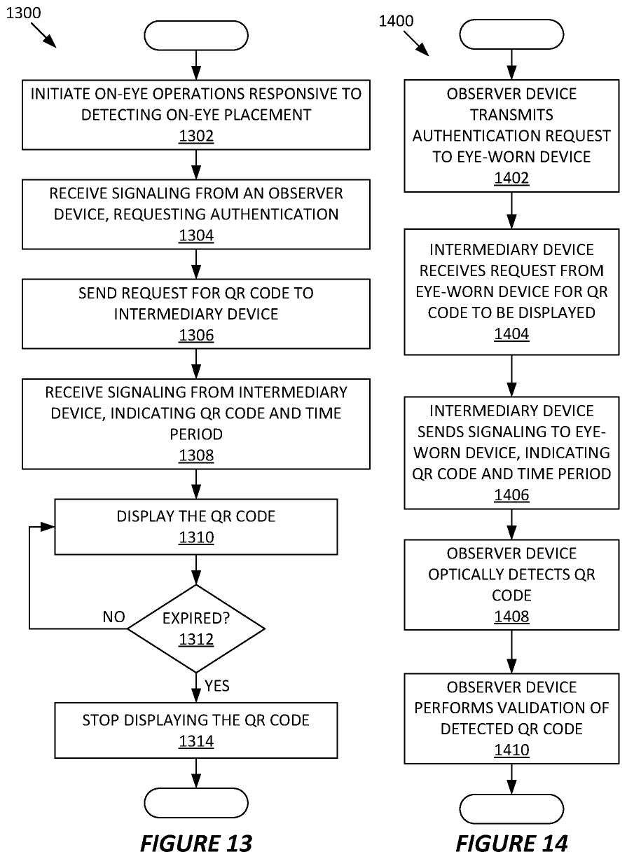

FIGS. 13 and 14 are similar to FIGS. 11 and 12 and, like those figures, FIGS. 13 and 14 represent an overall authentication procedure performed by the system shown in FIG. 10. The method 1300 depicted in FIG. 13 illustrates operations by the eye-worn device 10 and the method 1400 illustrates complementary or corresponding operations by the observer and intermediary devices 120 and 140.

However, after initiating on-eye operations (Block 1302), the eye-worn device 10 receives (Block 1304) signaling directly from the observer device 120, requesting authentication, rather than receiving such signaling through the intermediary device 140. The eye-worn device 10 responds to the request by sending (Block 1306) a request to the intermediary device 140 for a QR code and operations continue with the eye-worn device 10 receiving (Block 1308) signaling from the intermediary device 140, indicating the QR code and the time period for displaying it. The eye-worn device 10 then displays the QR code for the specified time period (Blocks 1310, 1312, and 1314).

Corresponding operations by the observer and intermediary devices 120 and 140 include the observer device 120 transmitting (Block 1402) the authentication request to the eye-worn device 10, and the intermediary device 140 correspondingly receiving (Block 1404) the request from the eye-worn device 10 for the QR code to be displayed. The intermediary device 140 responds to that request by sending (Block 1406) signaling to the eye-worn device 10, indicating the QR code and the time period for displaying it. Further operations include the observer device 120 optically detecting (Block 1408) the displayed QR code and validating (Block 1410) the detected QR code.

Again, although not shown, there may be signaling between the observer device 120 and the intermediary device 140, e.g., with the intermediary device 140 indicating to the observer device 120 the QR code to be displayed. Alternatively, the observer device 120 may obtain that information from the cloud, e.g., a remote server available via the Internet. Likewise, the intermediary device 140 may communicate with the remote server to learn which QR code should be displayed for this particular authentication procedure, and correspondingly identify that code to the eye-worn device 10 and/or the observer device 120.

With FIGS. 11-14 in mind, in one or more embodiments, a system includes an eye-worn device 10 comprising: a substrate 12 defining an annular area 44 surrounding a central opening 18 corresponding to a lens area of the eye of a wearer; and a display 40 covering at least a portion of the annular area 44 and facing outward for displaying an indication 42 to an observer device having a line-of-sight to the eye-worn device 10. The system further includes a device 120 operative as the observer device. The device 120 comprising authentication interface circuitry 130 configured for optical detection of the indication 42 as a detected indication and further comprising processing circuitry 122 configured for authentication of the detected indication. The device 120 further comprises communication circuitry 132 configured for receiving signaling indicating an authentication symbol, where authentication of the detected indication comprises verifying that the detected indication matches the authentication symbol.

The device 120 in one or more embodiments is configured to communicate with an intermediary device 140 via the communication circuitry 132, where the intermediary device 140 is further included in the system and is associated with the eye-worn device 10. The intermediary device 140 transmits signaling that is received at the device 120 as the aforementioned signaling received at the observer device 120.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-25. (canceled)

26. An eye-worn device comprising:
a substrate defining an annular area surrounding a central opening corresponding to a lens area of the eye of a wearer; and
a display covering at least a portion of the annular area and facing outward for displaying an indication to an observer device having a line-of-sight to the eye-worn device.

27. The eye-worn device according to claim 26, wherein the indication is an authentication symbol.

28. The eye-worn device according to claim 27, wherein the authentication symbol is a color or pattern.

29. The eye-worn device according to claim 26, wherein the eye-worn device is configured to determine the indication based on at least one of: information received via a communication circuitry of the eye-worn device, or information stored in a memory of the eye-worn device.

30. The eye-worn device according to claim 26, wherein the display is bi-stable for persistent displaying of the indication without onboard power, and wherein the eye-worn device includes electrical contacts providing display control to an external device, for setting the indication.

31. The eye-worn device according to claim 26, wherein the eye-worn device includes control circuitry configured to control the display and configured to set the indication responsive to signaling received via a set of electrical contacts or received wirelessly via a communication circuitry associated with the control circuitry.

32. The eye-worn device according to claim 26, wherein the eye-worn device includes a communication circuitry configured to receive wireless signaling and control circuitry that is configured to set the indication responsive to the wireless signaling.

33. The eye-worn device according to claim 32, wherein the control circuitry is configured to respond to an authentication request signal received via the communication circuitry by controlling the display to display the indication as an authentication response to the authentication request.

34. The eye-worn device according to claim 33, wherein the control circuitry is configured to clear or reset the indication after an elapsed time from receipt of the authentication request signal.

35. The eye-worn device according to claim 33, wherein the control circuitry is configured to update the indication, responsive to further authentication signaling received via the communication circuitry.

36. The eye-worn device according to claim 33, wherein the control circuitry is configured to update the indication and to transmit, via the communication circuitry, signaling indicating the update.

37. The eye-worn device according to claim 26, wherein the display is a reflective display.

38. The eye-worn device according to claim 26, wherein the display comprises a pixel array.

39. The eye-worn device according to claim 38, wherein pixels of the pixel array comprise Microelectromechanical Systems (MEMS) mirrors that form the indication in dependence on an applied mirror actuation pattern.

40. The eye-worn device according to claim 39, wherein the MEMS mirrors are bistable, for static holding of a last applied mirror actuation pattern.

41. A system comprising:
an eye-worn device comprising:
a substrate defining an annular area surrounding a central opening corresponding to a lens area of the eye of a wearer; and
a display covering at least a portion of the annular area and facing outward for displaying an indication to an observer device having a line-of-sight to the eye-worn device; and
a device operative as the observer device, the device comprising authentication interface circuitry configured for optical detection of the indication as a detected indication and further comprising processing circuitry configured for authentication of the detected indication.

42. The system according to claim 41, wherein the device further comprises communication circuitry configured for receiving signaling indicating an authentication symbol, and wherein authentication of the detected indication comprises verifying that the detected indication matches the authentication symbol.

43. The system according to claim 42, wherein the system further comprises an intermediary device and wherein the device is configured to communicate with the intermediary device via the communication circuitry, wherein the intermediary device is associated with the eye-worn device and transmits signaling that is received at the device as the received signaling.

44. A method of operation by an eye-worn device having a display that faces outward for displaying indications to an observer device having a line-of-sight to the eye-worn device, the method comprising:
receiving an authentication request from the observer device or from an intermediary device that is communicatively coupled to the observer device; and
displaying an indication as an authentication response, for optical detection by the observer device.

45. The method according to claim wherein the indication is an authentication symbol comprising a color or pattern.

46. The method according to claim further comprising determining the indication from signaling received via communication circuitry of the eye-worn device, the signaling transmitted by the observer device or the intermediary device.

47. The method according to claim further comprising determining the indication from information stored in a memory of the eye-worn device.

48. The method according to claim further comprising clearing or resetting the indication after an elapsed time from receipt of the authentication request signal.

49. The method according to claim 48, further comprising updating the indication, responsive to further authentication signaling received via the communication circuitry, the further authentication signaling transmitted by the observer device or the intermediary device.

50. The method according to claim further comprising transmitting signaling identifying the indication, for receipt by the observer device or the intermediate device.
